(19) United States
(12) Patent Application Publication
(10) Pub. No.: US 2024/0258968 A1
(43) Pub. Date: Aug. 1, 2024

(54) TRACKER HEALTH

(71) Applicant: Nextracker LLC, Fremont, CA (US)

(72) Inventors: Jacob Mark Morin, Phoenix, AZ (US); David Kresse, Walnut Creek, CA (US); Ricardo Delgado-Nanez, San Jose, CA (US)

(21) Appl. No.: 18/426,846

(22) Filed: Jan. 30, 2024

Related U.S. Application Data
(60) Provisional application No. 63/442,380, filed on Jan. 31, 2023.

(51) Int. Cl. H02S 50/10; H02S 20/32

(52) U.S. Cl. CPC H02S 50/10; H02S 20/32

(57) ABSTRACT

A method for assessing health of a solar tracker includes receiving data associated with a parameter of a plurality of solar trackers of a solar array, determining a health status tier from data received for one or more of the plurality of solar trackers, assigning the determined health status tier to the one or more of the plurality of solar trackers, and instructing solar trackers of the plurality of solar trackers assigned to a first health status tier to transition to a predetermined position.

### RELATED MATTERS

This application claims the benefit of U.S. Provisional Patent Application No. 63/442,380 filed Jan. 31, 2023, the entire contents of which are incorporated herein by reference.

### TECHNICAL FIELD

The present disclosure relates to solar power generation systems, and more particularly, to assessing the health of the solar tracking system.

### BACKGROUND

Solar cells and solar panels are most efficient in sunny conditions when oriented towards the sun at a certain angle. Many solar panel systems are designed in combination with solar trackers, which follow the sun's trajectory across the sky from east to west in order to maximize the electrical generation capabilities of the systems. The relatively low energy produced by a single solar cell requires the use of thousands of solar cells, arranged in an array, to generate energy in sufficient magnitude to be usable, for example as part of an energy grid. As a result, solar trackers have been developed that are quite large, spanning hundreds of feet in length and including hundreds to thousands of individual solar modules.

Solar trackers are installed in myriad environments, many of which subject the solar trackers to extreme conditions. As can be appreciated, various forms of maintenance are required due to years of direct sunlight, wind loading, wind borne debris, such as sand, dirt, and other small and large foreign objects, extreme temperatures, etc. in order to ensure continued operation of the solar trackers. Due to the enormous size of the solar trackers, it can be difficult to ascertain which individual solar module or solar module array of the solar tracker is experiencing, or about to experience, an issue that will cause the solar module array to go offline and reduce the efficiency and/or capacity of the solar tracker. The present disclosure seeks to address shortcomings of prior tracker systems.

### SUMMARY

In accordance with an aspect of the present disclosure, a method for assessing health of a solar tracker includes receiving data associated with a parameter of a plurality of solar trackers of a solar array, determining a health status tier from data received for one or more of the plurality of solar trackers, assigning the determined health status tier to the one or more of the plurality of solar trackers, and instructing solar trackers of the plurality of solar trackers assigned to a first health status tier to transition to a predetermined position.

In aspects, assigning the determined health status tier may include assigning the determined health status tier to one or more of a plurality of controllers associated with each respective solar tracker of the plurality of solar trackers.

In certain aspects, instructing solar trackers may include transmitting an instruction from one or more network control units operably coupled to one or more of the plurality of controllers to the plurality of controllers to transition solar trackers of the plurality of solar trackers having a controller assigned to the first health status tier to the predetermined position.

In other aspects, the method may include determining, via each controller of the plurality of controllers, if each respective controller of the plurality of controllers is affected by the transmitted instructions.

In certain aspects, the method may include transitioning solar trackers of the plurality of solar trackers operably coupled to a controller of the plurality of controllers determined to be affected by the transmitted instructions to the predetermined position.

In aspects, receiving the data associated with the parameter may include receiving data associated with a voltage of a respective storage medium operably coupled to each respective solar tracker of the plurality of solar trackers.

In other aspects, receiving the data associated with the parameter may include receiving data associated with an electrical current of a respective drive assembly operably coupled to each respective solar tracker of the plurality of solar trackers.

In certain aspects, determining the health status tier may include assigning the first health status tier if the received electrical current is less than a first predetermined threshold, assigning a second health status tier if the received electrical current is greater than the first predetermined threshold and less than a second predetermined threshold, and assigning a third health status tier if the received electrical current is greater than the second predetermined threshold.

In accordance with another aspect of the present disclosure, a system for assessing a health status of a solar tracker includes a plurality of, each controller operably coupled to a respective solar tracker of a plurality of solar trackers and a plurality of network control units, each network control unit operably coupled to one or more controllers of the plurality of controllers, wherein each controller of the plurality of controllers includes a processor and a memory storing instructions, which when executed, cause the processor to receive data associated with a parameter of a corresponding controller of the plurality of controllers, determine a health status tier for each controller of the plurality of controllers from the received data, receive instructions for a corresponding network control unit to transition solar trackers of the plurality of solar trackers associated with a controller determined to be within a first health status tier to a predetermined position, and determine if the corresponding solar tracker is affected by the received instructions.

In aspects, the system may include a plurality of storage mediums, each storage medium operably coupled to a respective controller of the plurality of controllers.

In certain aspects, the instructions, which when executed, may cause the processor to receive voltage data from a corresponding storage medium of the plurality of storage mediums.

In other aspects, the system may include a plurality of drive assemblies, each drive assembly operably coupled to a respective controller of the plurality of controllers.

In certain aspects, the instructions, which when executed, may cause the processor to receive electrical current data from a corresponding storage medium of the plurality of storage mediums.

In aspects, the memory may store further instructions, which when executed, cause the processor to cause the drive assembly operably coupled to the controller, to transition the corresponding solar tracker to the predetermined position when it is determined that the corresponding solar tracker is affected by the received instructions.

In accordance with another aspect of the present disclosure, a system for assessing a health status of a solar tracker includes a plurality of controllers, each controller operably coupled to a respective solar tracker of a plurality of solar trackers, a network control unit operably coupled to the plurality of controllers, and a remote host operably coupled to the network control unit, the remote host including a processor and a memory storing instructions, which when executed, cause the processor to receive data associated with a parameter of each of the plurality of controllers, determine a health status tier for each of the plurality of controllers from the received data, and transmit an assigned health status tier to each respective controller of the plurality of controllers.

In aspects, the memory may store further instructions, which when executed, cause the processor to transmit instructions from the network control unit to the plurality of controllers to transition solar trackers of the plurality of solar trackers having a controller assigned to a first health status tier to a predetermined position.

In other aspects, the system may include a plurality of storage mediums, each storage medium of the plurality of storage mediums operably coupled to a corresponding controller of the plurality of controllers.

In certain aspects, the instructions, when executed, may cause the processor to receive voltage data associated with each storage medium of the plurality of storage mediums.

In other aspects, the system may include a plurality of drive assemblies, each drive assembly of the plurality of drive assemblies operably coupled to a corresponding controller of the plurality of controllers.

In aspects, the instructions, when executed, may cause the processor to receive electrical current data associated with each drive assembly of the plurality of drive assemblies.

### BRIEF DESCRIPTION OF THE DRAWINGS

Various aspects and features of the present disclosure are described hereinbelow with reference to the drawings, wherein:

FIG. 1 illustrates a solar tracker array including multiple solar trackers in accordance with the present disclosure;

FIG. 2 is a perspective view of a solar tracker of the solar tracker array of FIG. 1;

FIG. 3 is a schematic view of a solar tracking control and information system provided in accordance with the present disclosure; and

FIG. 4 is a flow diagram of a method of assessing a health status of a solar tracker provided in accordance with the present disclosure.

### DETAILED DESCRIPTION

The present disclosure is directed to a system and method for assessing a health status of solar trackers of a solar tracker array. The system includes a solar tracking system having a plurality of rows of solar panel modules (SPMs), sensors, self-powered controllers (SPCs), and network control units (NCUs). The NCUs are coupled to a controller or NX Supervisory Control and Data Acquisition (NX SCADA), which in turn, is coupled to the internet or cloud, and ultimately a remote host. The remote host monitors or otherwise compiles data associated with each SPCᵢ, such as a voltage of various storage mediums (SMs), such as batteries, amongst others, electrical current of an electric motor coupled to a drive assembly (DAᵢ), tracker position, wind speed, etc.

The remote host assigns each SPCᵢ of the solar tracking array to a health status tier based on the data received each respective SPCᵢ. In embodiments, an SPCᵢ having an SMᵢ with low voltage and/or a DAᵢ with high electrical currents is assigned to a first health status tier, or tier 1. An SPCᵢ having an SMᵢ with good voltage and/or a DAᵢ with good electrical currents is assigned to a second health status tier, or tier 2. An SPCᵢ having an SMᵢ with great voltage and/or a DAᵢ with low electrical currents is assigned to a third health status tier, or tier 3. As can be appreciated, the health status tier of each SPCᵢ can be reassessed periodically and updated as necessary. The remote host assigns a health status tier to each SPCᵢ based upon the analysis of the data and transmits the health status tier to each SPCᵢ. Although generally described as being analyzed and determined by the remote host, it is envisioned that each SPCᵢ may analyze its own data and assign itself a health status tier independent of the remote host.

Concurrent with monitoring the health status of each of the SPCs of the solar tracker array, the remote host monitors data from weather stations monitoring wind speed and wind direction data at the location at which the solar tracking system is located and/or external weather forecast data including both publicly available forecast data and/or subscription-based paid for services. The remote host determines if one or more alarms should be sent from the NCUs to the SPCs of the solar tracking system to place SPMs in a predetermined position due to wind conditions, which in embodiments can be a stow position. In embodiments, based upon the current or predicted wind speed, the remote host instructs the NCUs to send a first alarm to the SPCs indicating that that SPCs within the first health status tier, or tier 1, are to move to the predetermined position. It is envisioned that the predetermined position may be modified based on the assigned health tier of each SPCᵢ. In this manner, the NCUs identify a position each SPCᵢ is able to safely transition to before overloading the drive assembly, overdrawing the batter, etc. It is contemplated that the NCUs or SPCs may modify the predetermined position in real-time based upon the monitored battery voltage and/or drive assembly electrical currents (e.g., instruct the SPCᵢ to stop transitioning to the predetermined position).

As the SPCs are aware of their health status tier, only those SPCs within the first health status tier will transition its corresponding SPMᵢ to a predetermined position. The remaining SPCs maintain normal operating conditions and await further instructions from the NCUs. In embodiments, based upon the current or predicted wind speed, the remote host instructs the NCUs to send a second alarm to the SPCs indicating that SPCs within the second health status tier, or tier 2, are to transition its corresponding SPMᵢ to the predetermined position, which may be different than the predetermined position for SPCs within the first health tier, and depending upon the current or predicted wind speed, the remote host instructs the NCUs to send a third alarm to the SPCs indicating that SPCs within the third health status tier, or tier 3, are to transition its corresponding SPMᵢ to the predetermined position, which may be different than the predetermined position for SPCs within the first and second health tiers. It is envisioned that the first, second, and third alarms may instruct SPCs within one or more of the health status tiers to transition their corresponding SPMi to their respective predetermined positions (e.g., tiers 1 and 2, tiers 1 and 3, tiers 2 and 3, tiers 1, 2, and 3, etc.). These and other aspects of the present disclosure will be described in detail herein below with reference to the drawings.

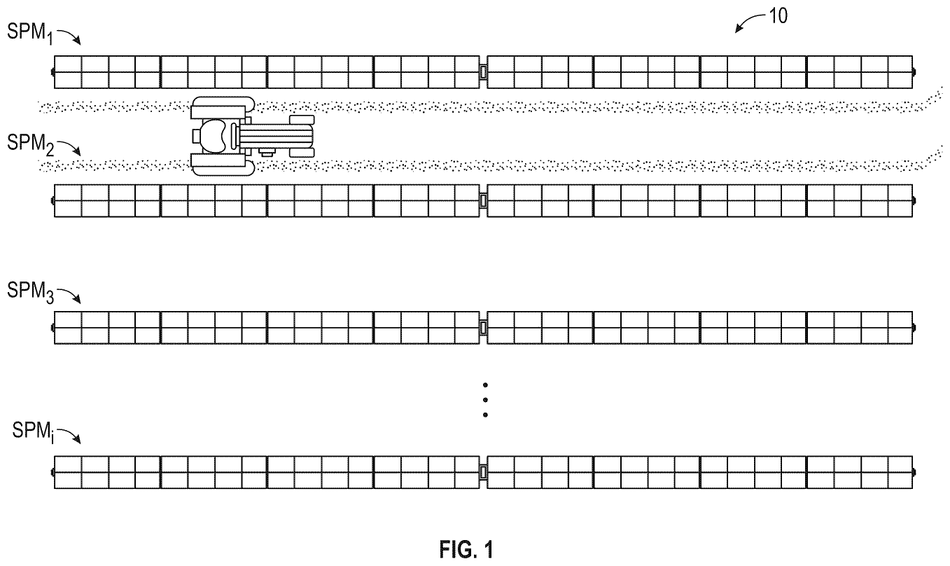

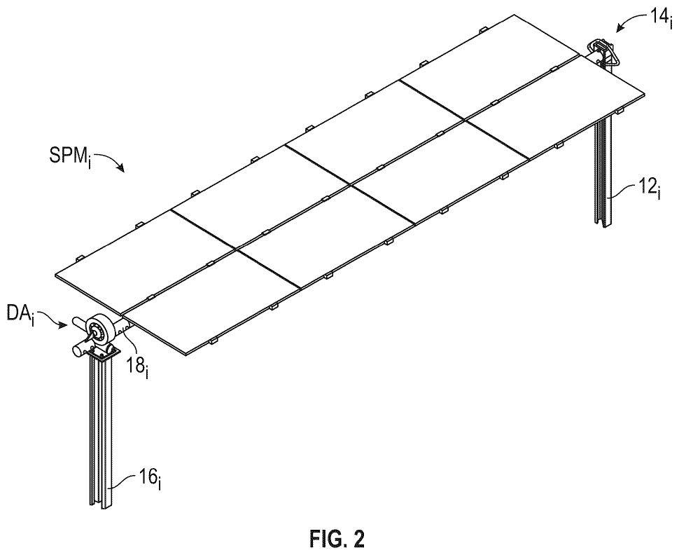

Referring now to the drawings, FIGS. 1-3 illustrate a solar tracking system 10, which is a distributed peer-to-peer network having a plurality of rows of solar panel modules (SPMs) SPM₁ . . . SPMᵢ forming a grid of solar panel modules. Each SPMᵢ (here i=1-8), though other values are contemplated, is coupled to a corresponding self-powered controller (SPCᵢ) and drive assembly (DAᵢ). In this matter, each SPMᵢ includes at least one first pier 12ᵢ supporting a pivot device 14ᵢ (e.g., a bearing) and at least one second pier 16ᵢ supporting a drive assembly DAᵢ (e.g., a slew drive). The drive assembly DAᵢ is operably coupled to a torque tube 18ᵢ rotatably supported by the pivot device 14ᵢ on a first end and rotatably coupled to the drive assembly DAᵢ on a second, opposite end. In embodiments, the torque tube 18ᵢ may be a Hollow Structural Steel (HSS) pipe defining a cylindrical profile with an outer dimension between approximately 1 inch and 10 inches, although it is envisioned that the torque tube 18ᵢ may include any suitable outer dimension and may include any suitable profile, such as square, rectangular, D-shaped, amongst others without departing from the scope of the present disclosure.

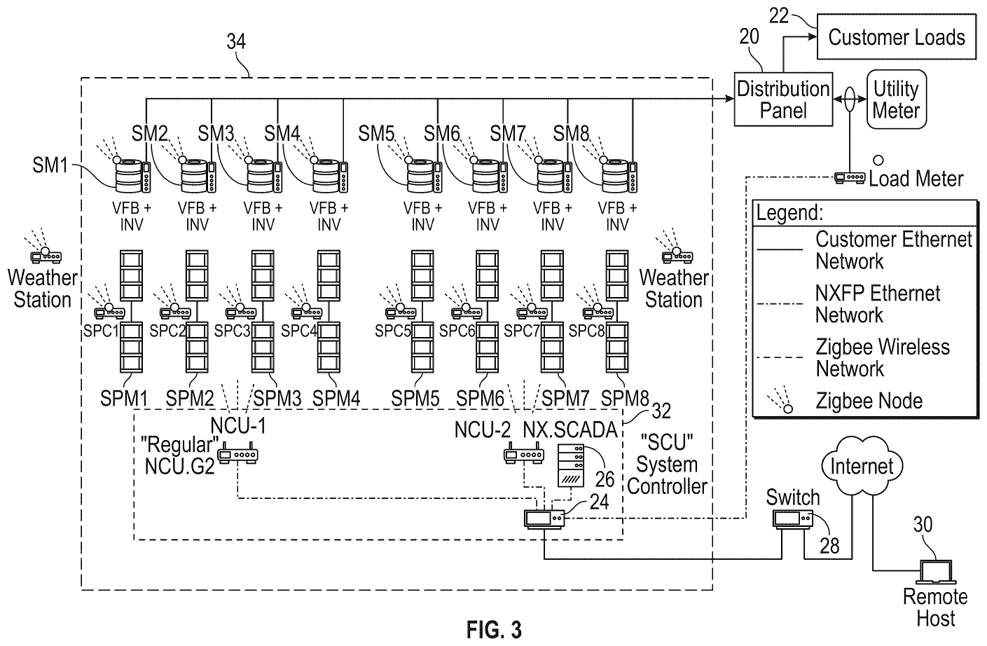

With reference to FIG. 3, each SPMᵢ has logic for orienting its corresponding drive assembly DAᵢ and thus SPMᵢ based on orientation commands. As one example, an SPCᵢ received an orientation command from a network control unit (described in further detail hereinbelow) to orient an incident angle θᵢ between the SPCᵢ and the sun. The corresponding drive assembly DAᵢ positions the SPMᵢ to the angle θᵢ. Each of the rows of solar panel modules SPMᵢ is able to be oriented independently of the other rows.

Each of the rows of solar panel modules SPMᵢ receives light, converts the light into electricity, and stores the electricity in a corresponding storage medium, SMᵢ, for i=1 to 8, such as a battery or other suitable storage medium. The storage medium SM₁ . . . SM₈ are ganged together and electrically coupled through a distribution panel 20 to customer loads 22. Network control units (NCU) NCU₁ and NCU₂ are each wirelessly coupled to one or more of the SPMs. In embodiments, NCU₁ is wirelessly coupled to SPCs SPC₁ to SPC₄ and NCU₂ is wirelessly coupled to SPCs SPC₅ to SPC₈. NCU1 and NCU2 are both coupled over an Ethernet cable to an NXFP switch 24. The switch 24 couples NCU₁ and NCU₂ to a controller or NX Supervisory Control and Data Acquisition (SCADA) 26, which in turn is coupled to a switch 28 coupled to a remote host 30 over a network such as a cloud network. In some embodiments, the remote host 30 performs processing such as generating performance models, retrieving weather data, amongst others. For ease of reference, the combination of NCU₁, NCU₂, NX SCADA 26, and NXFP switch 24 is referred to as an “SCU” system controller 32. Together, the components enclosed by the dotted line 34 are collectively referred to as “grid” or “zone” 34.

In embodiments, each NCU in the zone 34 is coupled to each of the remaining NCUs in the zone 34, thereby forming a mesh architecture. Thus, if for any reason NCU₁ loses communication to the NX SCADA 26, NCU₁ is able to communicate with the NX SCADA 26 through NCU₂. In this manner, each NCU in the zone 34 acts as a gateway to the NX SCADA 26 for any other NCU in the zone 34. As can be appreciated, this added redundancy provides a fail-safe network. In one non-limiting embodiment, the NCUs in the zone 34 are wirelessly coupled to one another.

As can be appreciated, FIG. 3 has been simplified for ease of illustration. It is envisioned that the zone 34 may contain fewer or more than 8 SPMs and 2 NCUs. In one non-limiting embodiment, the ratio of SPCs to NCUs is at least between 50:1 to 100:1. In this manner, during normal operation, NCU₁ communicates with SPC₁ through SPC₅₀, NCU₂ communicates with SPC₅₁ to SPC₁₀₀, etc.

With continued reference to FIG. 3, each SPCᵢ transmits data associated with its SPMᵢ to the cloud (e.g., internet) or remote host 30, which in turn, monitors, compiles, and/or analyzes the data associated with each SPCᵢ to assign each SPCᵢ to a health status tier. The health status tier assigned to each SPCᵢ is saved within the SPCᵢ such that the SPCᵢ knows or otherwise understands which health status tier it is assigned, thereby enabling the SPCᵢ to respond to commands and/or messages transmitted to the SPCᵢ from the NCUᵢ, as will be described in further detail hereinbelow. It is envisioned that the health status tier for each SPCᵢ may be updated continuously or periodically, such as once an hour, once a day, once a week, once a month, etc.

Although generally described as being analyzed by the remote host 30, it is envisioned that one or more of the SPCs may be able to analyze data and assign itself a health status tier. The self-assigned health status tier of each SPCᵢ may then be transmitted to the remote host, which in turn, may generate a map or list of SPCs and their assigned health status tier. It is envisioned that the software may group NCUs according to their assigned health status tier, and in embodiments, messages or alerts may be generated and displayed to the user to indicate that one or more NCUs may require attention and/or maintenance. In embodiments, each SPCi may not transmit its assigned health status tier, and rather, appropriately respond to messages transmitted by the NCUs, as will be described in further detail hereinbelow.

In embodiments, the SPCs monitor voltage associated with one or more of the SMs of each row of solar panel modules SPMᵢ. The voltage data collected by the SPCs is utilized to assign a health status tier to each SPCᵢ. In this manner, an SPCᵢ associated with an SMᵢ having a low voltage is assigned a health status of tier 1, an SPCᵢ associated with an SMᵢ having a good voltage is assigned a health status of tier 2, and an SPCᵢ associated with an SMᵢ having a great voltage is assigned a health status tier of 3. As can be appreciated, the measured voltage is compared to at least two predetermined thresholds, where a voltage less than the first predetermined threshold corresponds to health status tier 1, a voltage greater than or equal to the first predetermined threshold but less than or equal to a second predetermined threshold corresponds to health status tier 2, and a voltage greater than the second predetermined threshold corresponds to health status tier 3. In one non-limiting embodiment, the SPCs may monitor a rate at which the SMs are discharged (e.g., voltage drop over a predetermined period of time). As can be appreciated, the SMs are discharged during nighttime hours due to various loads or external factors and the rate at which the SMs are discharged is indicative of an SMᵢ that is failing or otherwise unable to operate at an acceptable level. In this manner, an SPCᵢ associated with an SMᵢ having a high discharge rate (or greater than first predetermined threshold) is assigned to health status tier 1, an SPCᵢ associated with an SMᵢ having a good discharge rate (or greater than or equal to a second first predetermined threshold but less than or equal to the first predetermined threshold) is assigned to health status tier 2, and a discharge rate less that is low (or less than the second predetermined threshold) is assigned to health status tier 3. It is contemplated that the discharge rate of the SMs may be compared over a period of time, such as hourly, daily, weekly, monthly, etc. to identify or calculate the predetermined thresholds.

In embodiments, the SPCs, monitors the flow of electrical energy from each SMᵢ to its associated drive assembly DAᵢ. As can be appreciated, each SMᵢ is charged throughout the day either from the SPMs or via a dedicated solar module (not shown) specifically for the purpose of charging the SMs and providing electrical energy to the drive assemblies DAs to maintain an orientation of the SPMs or change an orientation of the SPMs. The flow of electrical energy to and from the SMs is monitored and/or analyzed SPCs, for example, to ensure that the SPMs are accurately tracking the sun and to assess aspects of ambient conditions (e.g., cloud cover, shading, etc.). In this manner, the SMs, and in particular, the flow of energy from the SMs, can be analyzed to inform the user as to the health of the SPMs.

In embodiments, the SPCs monitor electrical current drawn by the drive assemblies DAs over a period of time, such as over an hour, over a day, over a week, over a month, etc. As can be appreciated, the drive assemblies DAs draw differing amounts of power, and therefore, current, depending upon the load placed upon them when maintaining an orientation of the SPMs or changing an orientation of the SPMs. A peak current for each DAᵢ is measured during movement of the SPM, excluding the inrush current during initiation of movement. Using the electrical current data associated with each drive assembly DAᵢ, SPMs are identified where a measured peak current is indicative of extra stress and/or strain is applied to its drive assembly DAᵢ caused by maintenance issues (e.g., failing bearings, failing motors, gearbox damage, etc.), external interference (e.g., vegetation, animals, etc.), and/or other factors, and a health status tier is assigned to each SPCᵢ. In this manner, an SPCᵢ associated with a DAᵢ drawing high electrical currents is assigned a health status of tier 1, an SPCᵢ associated with a DAᵢ drawing good electrical currents is assigned a health status of tier 2, and an SPCᵢ associated with a DAᵢ drawing low electrical currents is assigned a health status of tier 3. Similar to the voltage data described hereinabove, the measured electrical currents are compared to at least two predetermined thresholds, where an electrical current greater than the first predetermined threshold corresponds to health status tier 1, an electrical current less than or equal to the first predetermined threshold but greater than or equal to a second predetermined threshold corresponds to health status tier 2, and an electrical current less than the second predetermined threshold corresponds to health status tier 3. It is contemplated that the predetermined thresholds for the measured electrical currents may be modified based on the design needs of the solar tracking system 10 (e.g., calculated torque required to transition the SPMᵢ, motor type and/or size, DA type or size, etc.), and in one non-limiting embodiment, the first predetermined threshold is 5 A and the second predetermined threshold is 4 A. In embodiments, a DAᵢ having a measured electrical current greater than 7 A may be indicative of a serious problem that may require inspection and/or replacement of various components of the SPMᵢ associated with the DAᵢ. As can be appreciated, a measured electrical current of zero may likewise be indicative of a serious problem that may require inspection and/or replacement of various components of the SPMᵢ or the DAᵢ itself.

The solar tracking system 10 includes a weather station (not shown) for monitoring wind speed and wind direction data at the location at which the solar tracking system 10 is located. In embodiments, the solar tracking system 10 may monitor external weather forecast data including both publicly available forecast data and subscription-based paid for services that may be acquired by the operator of the solar tracking system 10. It is envisioned that the external weather forecast data may include wind speed, wind direction, freeze warnings, excessive heat, hail, flooding, snow, amongst others. In embodiments, utilizing the wind speed and wind direction data, the NCUs transmit one or more alarms or messages to the SPCs to orient their respective SPMi to a particular orientation or to a stow position (e.g., a predetermined position). In embodiments, the NCUs transmit a first alarm indicating that SPCs assigned to tracker health tier 1 should move to a stow position. The NCUs may then send out a second alarm indicating that SPCs assigned to tracker health tier 2 should move to a stow position. The NCUs may also send out a third alarm indicating that SPCs assigned to health tier 3 should move to a stow position.

It is envisioned that the predetermined position may be modified based on the assigned health tier of each SPCᵢ. In this manner, the NCUs identify a position each SPCᵢ is able to safely transition to before overloading the drive assembly, overdrawing the battery, etc. It is contemplated that the NCUs or SPCs may modify the predetermined position in real-time based upon the monitored battery voltage and/or drive assembly electrical currents (e.g., instruct the SPCᵢ to stop transitioning to the predetermined position). As can be appreciated, the measured electrical current may suddenly spike or otherwise increase quickly, indicating a potential malfunction or other issue with the SPMᵢ or DAᵢ. The NCUᵢ or SPCᵢ associated with the SPMᵢ or DAᵢ can instruct the SPMᵢ to stop transitioning and leave the SPMᵢ at that particular location to avoid damaging or further damaging the SPMᵢ.

In embodiments, the alarms may be sent based upon one or more predetermined thresholds corresponding to wind speed. In this manner, the first alarm may be sent when wind speed exceeds or is expected to exceed 30 mph, a second alarm may be sent when wind speed exceeds or is expected to exceed 40 mph, and the third alarm may be sent when wind speed exceeds or is expected to exceed 50 mph. As can be appreciated, the number of alarms and the parameters of the alarms may be adjusted depending upon site specific information (e.g., prevailing wind directions, peak wind speeds, etc.).

As the SPCs are aware of which health status tier they are assigned, the NCUs are not required to instruct specific SPCs to be placed in a predetermined position. Rather, the SPCs wait for a message from the NCUs corresponding to their assigned health status tier before orienting their respective SPMᵢ to the predetermined position. It is envisioned that if an SPCᵢ, or in embodiments, an NCUᵢ recognizes that specific SPCs are assigned to health status tier 1, the SPCᵢ may automatically transition to a predetermined position or the NCUᵢ may instruct the SPCᵢ to transition to a predetermined position in order to ensure that damage does not occur to the SPMᵢ within the health status tier 1 in the event that the SPCᵢ is unable to transition the SPMᵢ to a predetermined position due to low SMᵢ voltage or a mechanical issue. It is envisioned that the first, second, and third alarms may instruct SPCs within one or more of the health status tiers to transition their corresponding SPMi to a predetermined position (e.g., tiers 1 and 2, tiers 1 and 3, tiers 2 and 3, tiers 1, 2, and 3, etc.).

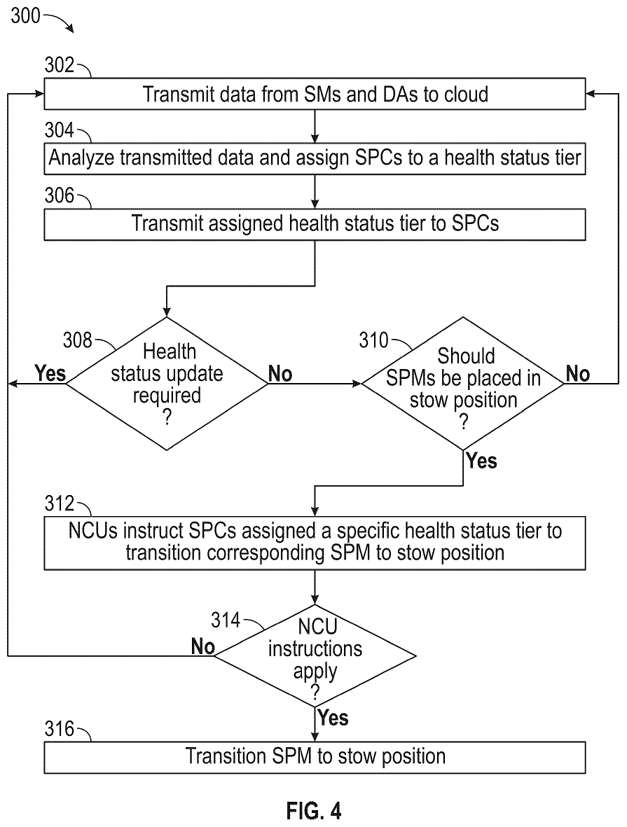

With reference to FIG. 4, a method of monitoring tracker health is illustrated and generally identified by reference numeral 300. As can be appreciated, the methods described herein may be a software program stored in a memory and executed by a processor on either the NX SCADA 26, the remote host 30, the NCUs, or the individual SPCs. Although generally described as transitioning to a stow position, as described hereinabove, it is contemplated that the SPMs may be transitioned to one or more predetermined positions without departing from the scope of the present disclosure. Initially, in step 302, the SPCs transmit data associated with corresponding SMs and DAs to cloud. In step 304, the transmitted data is analyzed and each SPCᵢ is assigned a health status tier of tier 1, tier 2, or tier 3. In step 306, the assigned health status tiers are transmitted back to the relevant SPCᵢ. With each SPCᵢ assigned a health status tier, in step 308 it is determined is a predetermined amount of time has passed and a health status update is required. If a health status update is required, the method returns to step 302 for further analysis of the transmitted data and any necessary updates to the assigned health status tiers. If no health status update is required, in step 310, it is determined if SPMs should be placed into the stow position, and if so, which health status tiers should be placed into the stow position. If it is determined that SPMs should not be placed into the stow position, the method returns to step 302. If it is determined that SPMs should be placed into the stow position, in step 312, the NCUs instructs SPCs assigned a specific health status tier to place the corresponding SPMs into the stow position. In step 314, the SPCs determine if the instructions transmitted by the NCUs apply, and if so, cause the appropriate SPMs to be placed in the stow position in step 316. If the instructions transmitted by the NCUs do not apply, the SPCs await further instructions and the method returns to step 302. Those having skill in the art will recognize that the method 300 described herein is not limiting and may be applied to any types of data and/or alarms described herein and may be repeated as many times as necessary or indefinitely.

Although generally described hereinabove, it is envisioned that the memory may include any non-transitory computer-readable storage media for storing data and/or software including instructions that are executable by the processor and which control the operation of the solar tracker array. In an embodiment, memory may include one or more storage devices such as solid-state storage devices, e.g., flash memory chips. Alternatively, or in addition to the one or more solid-state storage-devices, the memory may include one or more mass storage devices connected to the processor through a mass storage controller (not shown) and a communications bus (not shown).

Although the description of computer-readable media contained herein refers to solid-state storage, it should be appreciated by those skilled in the art that computer-readable storage media can be any available media that can be accessed by the processor. That is, computer readable storage media may include non-transitory, volatile and non-volatile, removable and non-removable media implemented in any method or technology for storage of information such as computer-readable instructions, data structures, program modules, or other data. For example, computer-readable storage media may include RAM, ROM, EPROM, EEPROM, flash memory or other solid-state memory technology, CD-ROM, DVD, Blu-Ray or other optical storage, magnetic cassettes, magnetic tape, magnetic disk storage or other magnetic storage devices, or any other medium which may be used to store the desired information, and which may be accessed by the NX SCADA 36.

While several embodiments of the disclosure have been shown in the drawings, it is not intended that the disclosure be limited thereto, as it is intended that the disclosure be as broad in scope as the art will allow and that the specification be read likewise. Therefore, the above description should not be construed as limiting, but merely as exemplifications of particular embodiments.

What is claimed is:

1. A method for assessing health of a solar tracker, comprising:
receiving data associated with a parameter of a plurality of solar trackers of a solar array;
determining a health status tier from data received for one or more of the plurality of solar trackers;
assigning the determined health status tier to the one or more of the plurality of solar trackers; and
instructing solar trackers of the plurality of solar trackers assigned to a first health status tier to transition to a predetermined position.

2. The method according to claim 1, wherein assigning the determined health status tier includes assigning the determined health status tier to one or more of a plurality of controllers associated with each respective solar tracker of the plurality of solar trackers.

3. The method according to claim 2, wherein instructing solar trackers includes transmitting an instruction from one or more network control units operably coupled to one or more of the plurality of controllers to transition solar trackers of the plurality of solar trackers having a controller assigned to the first health status tier to the predetermined position.

4. The method according to claim 3, further comprising determining, via each controller of the plurality of controllers, if each respective controller of the plurality of controllers is affected by the transmitted instructions.

5. The method according to claim 4, further comprising transitioning solar trackers of the plurality of solar trackers operably coupled to a controller of the plurality of controllers determined to be affected by the transmitted instructions to the predetermined position.

6. The method according to claim 1, wherein receiving the data associated with the parameter includes receiving data associated with a voltage of a respective storage medium operably coupled to each respective solar tracker of the plurality of solar trackers.

7. The method according to claim 1, wherein receiving the data associated with the parameter includes receiving data associated with an electrical current of a respective drive assembly operably coupled to each respective solar tracker of the plurality of solar trackers.

8. The method according to claim 7, wherein determining the health status tier includes assigning the first health status tier if the received electrical current is less than a first predetermined threshold, assigning a second health status tier if the received electrical current is greater than the first predetermined threshold and less than a second predetermined threshold, and assigning a third health status tier if the received electrical current is greater than the second predetermined threshold.

9. A system for assessing a health status of a solar tracker, comprising:
a plurality of controllers, each controller operably coupled to a respective solar tracker of a plurality of solar trackers; and
a plurality of network control units, each network control unit operably coupled to one or more controllers of the plurality of controllers,
wherein each controller of the plurality of controllers includes a processor and a memory storing instructions, which when executed, cause the processor to:
receive data associated with a parameter of a corresponding controller of the plurality of controllers;
determine a health status tier for each controller of the plurality of controllers from the received data;
receive instructions from a corresponding network control unit to transition solar trackers of the plurality of solar trackers associated with a controller determined to be within a first health status tier to a predetermined position; and
determine if the corresponding solar tracker is affected by the received instructions.

10. The system according to claim 9, further comprising a plurality of storage mediums, each storage medium operably coupled to a respective controller of the plurality of controllers.

11. The system according to claim 10, wherein the instructions, which when executed, cause the processor to receive voltage data from a corresponding storage medium of the plurality of storage mediums.

12. The system according to claim 9, further comprising a plurality of drive assemblies, each drive assembly operably coupled to a respective controller of the plurality of controllers.

13. The system according to claim 12, wherein the instructions, which when executed, cause the processor to receive electrical current data from a corresponding storage medium of the plurality of storage mediums.

14. The system according to claim 13, wherein the memory stores further instructions, which when executed, cause the processor to cause the drive assembly operably coupled to the controller, to transition the corresponding solar tracker to the predetermined position when it is determined that the corresponding solar tracker is affected by the received instructions.

15. A system for assessing a health status of a solar tracker, comprising:
a plurality of controllers, each controller operably coupled to a respective solar tracker of a plurality of solar trackers;
a network control unit operably coupled to the plurality of controllers; and
a remote host operably coupled to the network control unit, the remote host including a processor and a memory storing instructions, which when executed, cause the processor to:
receive data associated with a parameter of each of the plurality of controllers;
determine a health status tier for each of the plurality of controllers from the received data; and
transmit an assigned health status tier to each respective controller of the plurality of controllers.

16. The system according to claim 15, wherein the memory stores further instructions, which when executed, cause the processor to transmit instructions from the network control unit to the plurality of controllers to transition solar trackers of the plurality of solar trackers having a controller assigned to a first health status tier to a predetermined position.

17. The system according to claim 15, further comprising a plurality of storage mediums, each storage medium of the plurality of storage mediums operably coupled to a corresponding controller of the plurality of controllers.

18. The system according to claim 17, wherein the instructions, when executed, cause the processor to receive voltage data associated with each storage medium of the plurality of storage mediums.

19. The system according to claim 15, further comprising a plurality of drive assemblies, each drive assembly of the plurality of drive assemblies operably coupled to a corresponding controller of the plurality of controllers.

20. The system according to claim 19, wherein the instructions, when executed, cause the processor to receive electrical current data associated with each drive assembly of the plurality of drive assemblies.
